(19) United States
(12) Patent Application Publication
(10) Pub. No.: US 2026/0005290 A1
(43) Pub. Date: Jan. 1, 2026

(54) SOLID ELECTROLYTE, SOLID ELECTROLYTE MEMBRANE, POSITIVE ELECTRODE, AND ALL-SOLID-STATE RECHARGEABLE BATTERY

(71) Applicant: SAMSUNG SDI CO., LTD., Yongin-si, Gyeonggi-do (KR)

(72) Inventors: Guesung KIM, Yongin-si, Gyeonggi-do (KR); Kwang Jong SUH, Yongin-si, Gyeonggi-do (KR); Juyun KIM, Yongin-si, Gyeonggi-do (KR)

(73) Assignee: SAMSUNG SDI CO., LTD., Yongin-si, Gyeonggi-do (KR)

(21) Appl. No.: 18/879,863

(22) PCT Filed: Jan. 4, 2024
(86) PCT No.: PCT/KR2024/000160

§ 371 Date: Dec. 30, 2024

(30) Foreign Application Priority Data
Jan. 6, 2023 (KR) 10-2023-0002443

(51) Int. Cl. H01M 10/056; C01G 53/506; H01M 10/0525

(52) U.S. Cl. CPC H01M 10/056; C01G 53/506; H01M 10/0525; C01P 2006/40; H01M 2300/008

(57) ABSTRACT

Disclosed are a solid electrolyte, a solid electrolyte membrane, or a positive electrode for an all-solid-state rechargeable battery, or an all-solid-state rechargeable battery, the solid electrolyte including sulfide-based solid electrolyte particles, and a coating layer on a surface of the sulfide-based solid electrolyte particles, wherein the coating layer includes a (meth)acrylate including an alkylene glycol unit.

### TECHNICAL FIELD

Solid electrolytes, solid electrolyte membranes, positive electrodes, and all-solid-state rechargeable batteries are disclosed.

### BACKGROUND ART

Recently, as the risk of explosion in batteries using liquid electrolytes has been reported, development of batteries using solid electrolytes has been actively conducted. Among solid electrolytes, sulfide-based solid electrolytes with excellent ionic conductivity are widely used. However, sulfide-based solid electrolytes have the problem of being easily deteriorated by moisture. For example, the sulfide-based solid electrolyte reacts with moisture in the air and generates toxic hydrogen sulfide (H₂S) gas, which changes a structure of the sulfide-based solid electrolyte. Accordingly, when the sulfide-based solid electrolyte is exposed to the moisture, it may not only be dangerous, but also ionic conductivity of the electrolyte may sharply drop, failing in realizing performance. Therefore, the all-solid-state batteries should be manufactured and driven in a moisture-free environment.

### DISCLOSURE

A solid electrolyte capable of securing moisture stability and thermal stability of a sulfide-based solid electrolyte and minimizing resistance increase is provided, and by applying the same, a solid electrolyte membrane, a positive electrode, and an all-solid-state rechargeable battery with improved performance are provided.

In an embodiment, a solid electrolyte includes sulfide-based solid electrolyte particles, and a coating layer on a surface of the sulfide-based solid electrolyte particles, wherein the coating layer includes a (meth)acrylate including an alkylene glycol unit.

In another embodiment, a solid electrolyte membrane for an all-solid-state rechargeable battery including the solid electrolyte is provided.

In another embodiment, a positive electrode for an all-solid-state rechargeable battery includes a current collector and a positive electrode active material layer on the current collector, wherein the positive electrode active material layer includes the aforementioned solid electrolyte, a positive electrode active material, a conductive material, and a binder.

In another embodiment, an all-solid-state rechargeable battery includes a positive electrode, a negative electrode, and a solid electrolyte layer between the positive electrode and the negative electrode, wherein at least one of the positive electrode, the negative electrode, and the solid electrolyte layer includes the aforementioned solid electrolyte.

A solid electrolyte according to an embodiment of the present invention has high stability against moisture and heat, and can realize excellent performance by minimizing increase in resistance due to coating. Such a solid electrolyte membrane and a positive electrode and an all-solid-state rechargeable battery including such a solid electrolyte can be manufactured more easily and exhibit superior performance.

### DESCRIPTION OF THE DRAWINGS

FIGS. 1 and 2 are cross-sectional views schematically showing all-solid-state rechargeable batteries according to an embodiment.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, a laminate, a composite, a copolymer, an alloy, a blend, a reaction product, and the like of the constituents.

Here, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter may be measured by a method well known to those skilled in the art, for example, may be measured by a particle size analyzer, or may be measured by a transmission electron microscopic photograph or a scanning electron microscopic photograph.

Alternatively, it is possible to obtain an average particle diameter value by measuring it using a dynamic light scattering method, performing data analysis, counting the number of particles for each particle size range, and calculating from this. The average particle diameter may be measured by a microscope image or a particle size analyzer, and may mean a diameter (D50) of particles having a cumulative volume of 50 volume % in a particle size distribution.

Here, “or” is not to be construed as an exclusive meaning, for example, “A or B” is construed to include A, B, A+B, and the like.

“Substituted” means that at least one hydrogen atom is substituted with a substituent of a halogen atom (F, Cl, Br, I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

Here, for example, C1 to C20 mean that the number of carbon atoms is 1 to 20.

### Solid Electrolyte

In an embodiment, a solid electrolyte includes sulfide-based solid electrolyte particles, and a coating layer on a surface of the sulfide-based solid electrolyte particles, wherein the coating layer includes a (meth)acrylate including an alkylene glycol unit. The (meth)acrylate including the alkylene glycol unit can be coated on the surface of a sulfide-based solid electrolyte with a very thin thickness, thereby improving both the thermal stability and moisture stability of the solid electrolyte and minimizing the increase in resistance due to the coating.

The (meth)acrylate including the alkylene glycol unit may be a compound having an alkylene glycol unit and a (meth)acrylate functional group.

Here, (meth)acrylate means acrylate or methacrylate. The (meth)acrylate including the alkylene glycol unit may have 1 to 5 (meth)acrylate functional groups, for example, 1 or 2. In the alkylene glycol unit, the carbon number of the alkylene may be C1 to C10, or may be C1 to C8, C1 to C6, C1 to C4, C1 to C3, or C1 to C2. For example, the alkylene glycol may be methylene glycol or ethylene glycol. The (meth)acrylate including the alkylene glycol unit may include 2 to 100, for example, 2 to 80, 2 to 60, 2 to 40, 2 to 20, or 2 to 10 of the alkylene glycol units.

For example, the (meth)acrylate including the alkylene glycol unit may be a (meth)acrylate including an ethylene glycol unit. Specifically, the (meth)acrylate including the alkylene glycol unit may be represented by Chemical Formula 1 or Chemical Formula 2.

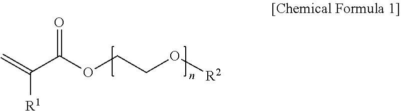

In Chemical Formula 1, R¹ is hydrogen or a methyl group, R² is a substituted or unsubstituted C1 to C20 alkyl group, and n is 2 to 100.

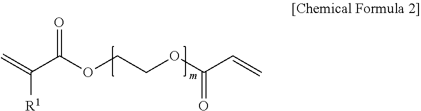

In Chemical Formula 2, R³ is hydrogen or a methyl group, and m is 2 to 100.

In Chemical Formula 1, R² may be, for example, a C1 to C16 alkyl group, a C1 to C14 alkyl group, a C1 to C12 alkyl group, or a C1 to C10 alkyl group, for example, a methyl group, an ethyl group, a propyl group, a butyl group, an ethylhexyl group, etc.

The n in Chemical Formula 1 and the m in Chemical Formula 2 represent the number of ethylene glycol units, and may be, for example, 2 to 80, 2 to 60, 2 to 40, 2 to 20, or 2 to 10.

As a specific example, the (meth)acrylate including the alkylene glycol unit may be one or two or more selected from poly(ethylene glycol) methyl ether (meth)acrylate, poly(ethylene glycol) ethyl ether (meth)acrylate, poly(ethylene glycol) di(meth)acrylate, di(ethylene glycol) di(meth)acrylate, tri(ethylene glycol) di(meth)acrylate, di(ethylene glycol) 2-ethylhexyl ether (meth)acrylate, di(ethylene glycol) methyl ether (meth)acrylate, and di(ethylene glycol) ethyl ether (meth)acrylate. These compounds have excellent coating quality and can improve the thermal and moisture stability of solid electrolytes.

The (meth)acrylate including the alkylene glycol unit according to an embodiment may be a compound having a relatively small molecular weight. For example, a weight average molecular weight of the (meth)acrylate including the alkylene glycol unit may be 100 g/mol to 500 g/mol. In this case, the (meth)acrylate including the alkylene glycol unit can be coated in a very thin thickness to exhibit excellent coating quality, and can improve the stability of the solid electrolyte against heat and moisture.

A content of the (meth)acrylate including the alkylene glycol unit is not particularly limited, but may be 0.001 parts by weight to 10 parts by weight, for example, 0.001 parts by weight to 8 parts by weight, 0.001 parts by weight to 6 parts by weight, 0.001 parts by weight to 4 parts by weight, 0.001 parts by weight to 2 parts by weight, 0.01 parts by weight to 1 part by weight, or 0.01 parts by weight to 0.1 parts by weight based on 100 parts by weight of the above sulfide-based solid electrolyte particles. Even if the aforementioned (meth)acrylate including the alkylene glycol unit is included in a small amount, it can be coated in a thin thickness on the surface of the sulfide-based solid electrolyte particles and exhibit excellent coating quality.

A thickness of the coating layer may be 1 nm to 50 nm, for example 1 nm to 40 nm, 1 nm to 30 nm, or 5 nm to 20 nm. The coating layer can be formed with a very thin thickness, thereby minimizing the increase in resistance due to the coating, and improving the performance of the solid electrolyte.

The coating layer may exist in the form of a continuous film or may exist in the form of an island on the surface of the sulfide-based solid electrolyte particles.

The sulfide-based solid electrolyte particles may include, for example Li₂S—P₂S₅, Li₂S—P₂S₅—LiX (wherein X is a halogen element, for example I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n is each an integer and Z is Ge, Zn, or Ga), Li₂S—GeS₂, Li₂S—SiS₂—Li₃PO₄, Li₂S—SiS₂—LiₚMO_{q} (wherein p and q each an integer and M is P, Si, Ge, B, Al, Ga, or In), or a combination thereof.

The sulfide-based solid electrolyte may be obtained by, for example, mixing Li₂S and P₂S₅ in a mole ratio of 50:50 to 90:10 or 50:50 to 80:20 and optionally, performing heat treatment. Within the mixing ratio range, a sulfide-based solid electrolyte having excellent ionic conductivity may be prepared.

Here, other components such as SiS₂, GeS₂, and B₂S₃ may be added to further improve the ionic conductivity.

Mechanical milling or solution method may be applied as a mixing method of sulfur-containing raw materials for preparing a sulfide-based solid electrolyte. The mechanical milling is to make starting materials into particulates by putting the starting materials and ball mills in a reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ionic conductivity may be improved. For example, the sulfide-based solid electrolyte may be prepared by mixing sulfur-containing raw materials and performing heat treatment two or more times. In this case, a sulfide-based solid electrolyte having high ionic conductivity and robustness may be prepared.

The sulfide-based solid electrolyte particles according to an embodiment, for example, may be prepared through a first heat treatment of mixing sulfur-containing raw materials and firing at 120° C. to 350° C. and a second heat treatment of mixing the resultant of the first heat treatment and firing the same at 350° C. to 800° C. The first heat treatment and the second heat treatment may be performed in an inert gas or nitrogen atmosphere, respectively. The first heat treatment may be performed for 1 hour to 10 hours, and the second heat treatment may be performed for 5 hours to 20 hours. Small raw materials may be milled through the first heat treatment, and a final solid electrolyte can be synthesized through the second heat treatment. Through such two or more heat treatments, a sulfide-based solid electrolyte having high ionic conductivity and high performance can be obtained, and such a solid electrolyte may be suitable for mass production. The temperature of the first heat treatment may be, for example, 150° C. to 330° C., or 200° C. to 300° C., and the temperature of the second heat treatment may be, for example, 380° C. to 700° C., or 400° C. to 600° C.

For example, the sulfide-based solid electrolyte particles may include argyrodite-type sulfide. The argyrodite-type sulfide may be represented by, for example, a chemical formula of LiₐM_{b}P_{c}S_{d}Aₑ (wherein a, b, c, d, and e are all 0 or more and 12 or less, M is Ge, Sn, Si, or a combination thereof, and A is F, Cl, Br, or I), and as a specific example, may be represented by a chemical formula of Li₇₋ₓPS₆₋ₓAₓ (wherein x is 0.2 or more and 1.8 or less, and A is F, Cl, Br, or I). The argyrodite-type sulfide may specifically be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, etc.

The sulfide-based solid electrolyte particles including such an argyrodite-type sulfide-based solid electrolyte may have high ionic conductivity close to the range of 10⁻⁴ to 10⁻² S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including this can have improved battery performances such as rate capability, coulombic efficiency, and cycle-life characteristics.

The argyrodite-type sulfide-based solid electrolyte may be prepared, for example, by mixing lithium sulfide and phosphorus sulfide, and optionally lithium halide. Heat treatment may be performed after mixing them. The heat treatment may include, for example, two or more heat treatment steps. The method of preparing the argyrodite-type sulfide-based solid electrolyte may include, for example, a first heat treatment in which raw materials are mixed and fired at 120° C. to 350° C., and a second heat treatment in which the resultant of the first heat treatment is mixed again and fired at 350° C. to 800° C.

The average particle size (D50) of the sulfide-based solid electrolyte particles may be, for example, 0.1 μm to 5.0 μm, and may be small particles of 0.1 μm to 1.9 μm or large particles of 2.0 μm to 5.0 μm. The average particle diameter of the sulfide-based solid electrolyte particles may be measured from an electron microscope image, for example, a particle size distribution may be obtained by measuring the size (diameter or length of the major axis) of about 20 particles in a scanning electron microscope image, and D50 may be calculated therefrom.

The solid electrolyte according to an embodiment may be prepared by mixing sulfide-based solid electrolyte particles and a (meth)acrylate including an alkylene glycol unit in a solvent and then drying. The solvent may be, for example, isobutyl isobutyrate, xylene, toluene, benzene, hexane, or a combination thereof. The drying may be, for example, vacuum drying at a temperature of 40° C. to 80° C. for 0.1 to 40 hours, or may be carried out in an inert gas at a temperature of 60° C. to 300° C. for 0.1 to 40 hours.

### Solid Electrolyte-Conductive Material Composite Material

In an embodiment, a composite material includes sulfide-based solid electrolyte particles, a carbon material, and a (meth)acrylate including an alkylene glycol unit on the surface of the sulfide-based solid electrolyte particles and the surface of the carbon material.

The composite material may be a composite of a solid electrolyte and a conductive material, and may be used for an electrode or a solid electrolyte membrane of an all-solid-state rechargeable battery. The composite material may be prepared by mixing sulfide-based solid electrolyte particles, carbon material, and a (meth)acrylate including an alkylene glycol unit in a solvent and then drying.

The carbon material may be, for example, natural graphite, artificial graphite, carbon black, acetylene black, ketjen black, a carbon nanofiber, a carbon nanotube, or a combination thereof, and may be, for example, a carbon nanofiber, a carbon nanotube, or a combination thereof. The solvent may be, for example, isobutyl isobutyrate, xylene, toluene, benzene, hexane, or a combination thereof. The drying may be, for example, vacuum drying at a temperature of 40° C. to 80° C.

The composite material has a high degree of dispersion during preparation, making it possible to manufacture an electrode or solid electrolyte membrane using only a very small amount of binder.

The meth)acrylate including the alkylene glycol unit may be present as a thin coating layer on the surface of the sulfide-based solid electrolyte particles and the carbon material. Because the sulfide-based solid electrolyte and the (meth)acrylate including the alkylene glycol unit have been described above, a detailed description is omitted.

A content of the carbon material may be 1 part by weight to 50 parts by weight, for example, 1 part by weight to 40 parts by weight, 1 part by weight to 30 parts by weight, 1 part by weight to 20 parts by weight, 1 part by weight to 10 parts by weight, or 1 part by weight to 5 parts by weight based on 100 parts by weight of the sulfide-based solid electrolyte particles.

A content of the (meth)acrylate including the alkylene glycol unit may be 0.001 parts by weight to 10 parts by weight, for example, 0.001 parts by weight to 8 parts by weight, 0.001 parts by weight to 6 parts by weight, 0.001 parts by weight to 4 parts by weight, 0.001 parts by weight to 2 parts by weight, 0.01 parts by weight to 1 part by weight, or 0.01 parts by weight to 0.1 parts by weight based on 100 parts by weight of the sulfide-based solid electrolyte particles and the carbon material. Even if the (meth)acrylate including the alkylene glycol unit is included in a small amount, it can be coated in a thin thickness on the surface of a sulfide-based solid electrolyte and a carbon material and exhibit excellent coating quality.

### Solid Electrolyte Membrane

In an embodiment, a solid electrolyte membrane for an all-solid-state rechargeable battery including the aforementioned solid electrolyte is provided. The solid electrolyte membrane may be located between the positive and negative electrodes in an all-solid-state rechargeable battery and acts as an electrolyte and a separator, and its thickness may be about 10 μm to 500 μm, 20 μm to 300 μm, or 30 μm to 100 μm. The aforementioned solid electrolyte includes sulfide-based solid electrolyte particles having high ionic conductivity, and includes a thin organic coating layer on its surface, so that it has high stability against heat and moisture and minimizes increase in resistance due to the coating, thereby enabling maximum performance to be realized. In addition, the solid electrolyte has a high degree of dispersion, so that a high-quality solid electrolyte film can be formed with only a small amount of binder.

In the solid electrolyte membrane, the average particle diameter (D50) of the solid electrolyte may be 2.0 μm to 5.0 μm, in which case excellent ionic conductivity and dispersibility can be realized.

The solid electrolyte membrane may further include an oxide-based solid electrolyte in addition to the aforementioned solid electrolyte. The oxide-based inorganic solid electrolyte may include for example Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (wherein M=Te, Nb, or Zr; and x is an integer of 1 to 10), or a combination thereof.

The solid electrolyte membrane may further include a binder in addition to the aforementioned solid electrolyte. The binder may be, but is not limited to, a styrene butadiene rubber, polytetrafluoroethylene, polyvinylidene fluoride, polyethylene, an acrylate-based polymer, or a combination thereof, and any binder used in the relevant technical field may be used. The acrylate-based polymer may be, for example, butyl acrylate, polyacrylate, polymethacrylate or a combination thereof.

### All-Solid-State Rechargeable Battery

In an embodiment, an all-solid-state rechargeable battery includes a positive electrode, a negative electrode, and a solid electrolyte layer between the positive electrode and the negative electrode, wherein at least one of the positive electrode, the negative electrode, and the solid electrolyte layer includes the aforementioned solid electrolyte. The solid electrolyte may be included in any one of the positive electrode, negative electrode, or solid electrolyte layers, or in two or more, or in all three. The all-solid-state rechargeable battery may also be referred to as an all-solid-state lithium rechargeable battery.

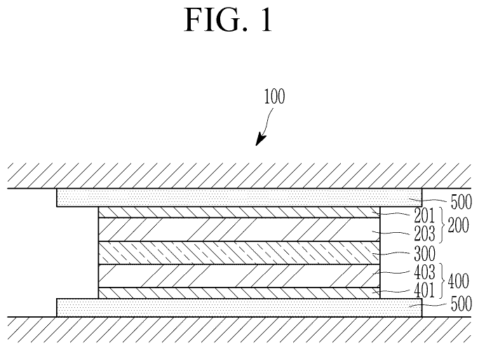

FIG. 1 is a cross-sectional view of an all-solid-state rechargeable battery according to an embodiment. Referring to FIG. 1, the all-solid-state rechargeable battery 100′ may have a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is housed in a case such as a pouch. The all-solid-state rechargeable battery 100′ may further include at least one elastic layer 500 on the outside of at least either one of the positive electrode 200 and the negative electrode 400. Although FIG. 1 shows one electrode assembly including the negative electrode 400, the solid electrolyte layer 300, and the positive electrode 200, an all-solid-state rechargeable battery can also be manufactured by stacking two or more electrode assemblies.

### Positive Electrode

In an embodiment, a positive electrode for an all-solid-state rechargeable battery includes a current collector and a positive electrode active material layer positioned on the current collector, wherein the positive electrode active material layer includes the aforementioned solid electrolyte, positive electrode active material, conductive material, and binder.

### Solid Electrolyte

The aforementioned positive electrode for an all-solid-state rechargeable battery implements high ionic conductivity by including the aforementioned solid electrolyte, and the problem of materials being deteriorated by heat and moisture is improved, while the increase in resistance is minimized, so that the manufacturing and distribution processes become easier, and the capacity, efficiency, and cycle-life characteristics can be improved.

In addition, the solid electrolyte has an organic material coated on its surface in a thin thickness, so it has excellent dispersibility, enables the manufacture of a positive electrode with a small amount of binder, and enables the manufacture of a positive electrode by a dry process. Because the solid electrolyte itself has been described above, a detailed description is omitted.

In the positive electrode, the average particle diameter (D50) of the solid electrolyte included in the positive electrode may be about 0.1 μm to 1.9 μm, which may be smaller than the average particle diameter of the solid electrolyte included in the solid electrolyte layer. The solid electrolyte satisfying the average particle size range can effectively penetrate between positive electrode active materials, and has excellent contact with the positive electrode active material and connectivity between solid electrolyte particles. The average particle size of the solid electrolyte particles may be measured from a microscope image, for example, by measuring the sizes of about 20 particles in a scanning electron microscope image to obtain a particle size distribution and calculating D50 therefrom.

A content of the solid electrolyte in the positive electrode may be 0.5 wt % to 35 wt %, for example, 0.5 wt % to 30 wt %, 1 wt % to 25 wt %, 3 wt % to 20 wt %, or 5 wt % to 17 wt % based on 100 wt % of the positive electrode active material layer.

### Conductive Material

The positive electrode active material layer may further include a conductive material. The conductive material is used to impart conductivity to the electrode, and may include, for example a carbon-based material such as natural graphite, artificial graphite, carbon black, acetylene black, ketjen black, a carbon nanofiber, carbon nanotube, and the like; a metal-based material of a metal powder or a metal fiber including copper, nickel, aluminum, silver, and the like; a conductive polymer such as a polyphenylene derivative; or a combination thereof.

In an embodiment, the conductive material may include a carbon material and a (meth)acrylate including an alkylene glycol unit on the surface of the carbon material. When manufacturing a positive electrode, a sulfide-based solid electrolyte, a carbon material, and a (meth)acrylate including an alkylene glycol unit are mixed in a solvent and then dried to manufacture a solid electrolyte-conductive material composite material, and this is mixed with a positive electrode active material and a binder to prepare a positive electrode slurry, and then the positive electrode slurry is coated on a current collector and dried and compressed to manufacture a positive electrode. By these methods, organic materials may be coated not only on the solid electrolyte within the positive electrode but also on the surface of the carbon material that acts as a conductive material. In this case, the dispersion of materials such as solid electrolyte and conductive material within the positive electrode is improved, the manufacturing process is easy, and the positive electrode can be manufactured with a small amount of binder, and thus the content of the binder can be reduced to maximize the capacity. It also becomes possible to manufacture the positive electrode by dry method.

The carbon material may be natural graphite, artificial graphite, carbon black, acetylene black, ketjen black, a carbon nanofiber, a carbon nanotube, or a combination thereof. For example, the carbon material may be a carbon nanofiber, a carbon nanotube, or a combination thereof, in which case the dispersibility of the positive electrode slurry may be improved and the overall electrical conductivity and ionic conductivity of the positive electrode may be improved.

The (meth)acrylate including the alkylene glycol unit may be coated in a film form or in an island form on the surface of the carbon material, or may form point contact between the solid electrolyte and the carbon material.

In the positive electrode, a content of the (meth)acrylate including the alkylene glycol unit may be 0.001 parts by weight to 10 parts by weight, for example, 0.001 parts by weight to 8 parts by weight, 0.001 parts by weight to 6 parts by weight, 0.001 parts by weight to 4 parts by weight, 0.001 parts by weight to 2 parts by weight, 0.01 parts by weight to 1 part by weight, or 0.01 parts by weight to 0.1 parts by weight based on 100 parts by weight of the sulfide-based solid electrolyte particles and the carbon material. Even if the (meth)acrylate including the alkylene glycol unit is included in a small amount, it can be coated in a thin thickness on the surface of the sulfide-based solid electrolyte particles and carbon materials and exhibit excellent coating quality.

A content of the carbon material may be 1 part by weight to 50 parts by weight, for example, 1 part by weight to 40 parts by weight, 1 part by weight to 30 parts by weight, 1 part by weight to 20 parts by weight, 1 part by weight to 10 parts by weight, or 1 part by weight to 5 parts by weight based on 100 parts by weight of the sulfide-based solid electrolyte particles.

A content of the conductive material in the positive electrode may be 0.1 wt % to 5 wt %, for example, 0.1 wt % to 3 wt %, 0.1 wt % to 2 wt %, or 0.1 wt % to 1 wt % based on 100 wt % of the positive electrode active material layer. In the content range, the conductive material can improve electrical conductivity without degrading battery performance.

### Positive Electrode Active Material

The positive electrode active material may be applied without limitation as long as it is generally used in all-solid-state rechargeable batteries. For example, the positive electrode active material may be a compound being capable of intercalating and deintercalating lithium, and may include a compound represented by one of the following chemical formulas.

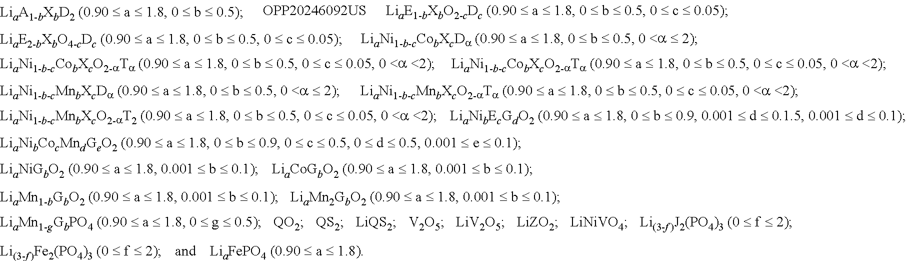

In the chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

The positive electrode active material may include lithium nickel-based oxide represented by Chemical Formula 11, lithium cobalt-based oxide represented by Chemical Formula 12, a lithium iron phosphate-based compound represented by Chemical Formula 13, or a combination thereof.

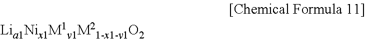

In Chemical Formula 11, 0.9≤a1≤1.8, 0.3≤x≤1, 0≤y1≤0.7, and M¹ and M² are one or more elements independently selected from Al, B, Ba, Ca, Ce, Co, Cr, Cu, F, Fe, Mg, Mn, Mo, Nb, P, S, Si, Sr, Ti, V, W, and Zr.

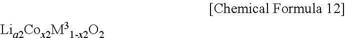

In Chemical Formula 12, 0.95≤a2≤1.8, 0.6≤x2≤1, and M³ is one or more elements selected from Al, B, Ba, Ca, Ce, Cr, Cu, F, Fe, Mg, Mn, Mo, Nb, P, S, Si, Sr, Ti, V, W, and Zr.

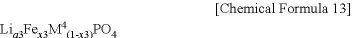

In Chemical Formula 13, 0.95a351.8, 0.6≤x3≤1, M⁴ is one or more elements selected from Al, B, Ba, Ca, Ce, Co, Cr, Cu, F, Fe, Mg, Mn, Mo, Nb, P, S, Si, Sr, Ti, V, W, and Zr.

An average particle diameter (D50) of the positive electrode active material may be 1 μm to 25 μm, for example 3 μm to 25 μm, 1 μm to 20 μm, 1 μm to 18 μm, 3 μm to 15 μm, or 5 μm to 15 μm. For example, the positive electrode active material may include small particles having an average particle diameter (D50) of 1 μm to 9 μm and large particles having an average particle diameter (D50) of 10 μm to 20 μm. The positive electrode active material having this particle size range can be harmoniously mixed with other components within the positive electrode active material layer and can achieve high capacity and high energy density.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

### Binder

The positive electrode active material layer may further include a binder. The binder serves to attach the positive electrode active material particles and the solid electrolyte particles well to each other, and also to attach the particles well to the current collector. Examples of the binder may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The binder may be included in an amount of 0.1 wt % to 5 wt %, 0.1 wt % to 3 wt %, 0.1 wt % to 2 wt %, or 0.1 wt % to 1 wt % based on the total weight of each component of the positive electrode for the all-solid-state rechargeable battery, or based on the total weight of the positive electrode active material layer. According to an embodiment, the positive electrode may be manufactured with a small amount of binder and may be manufactured dry, since it includes a solid electrolyte coated with the aforementioned organic material.

In an embodiment, the positive electrode active material layer may include 55 wt % to 99 wt % of the positive electrode active material, 0.5 wt % to 35 wt % of the solid electrolyte, 0.1 wt % to 5 wt % of the binder, and 0.1 wt % to 5 wt % of the conductive material, based on 100 wt % of the positive electrode active material layer. For example, the positive electrode active material layer may include 78 wt % to 94 wt % of the positive electrode active material, 5 wt % to 17 wt % of the solid electrolyte, 0.1 wt % to 3 wt % of the binder, and 0.1 wt % to 2 wt % of the conductive material.

Meanwhile, the positive electrode active material layer may further include an oxide-based inorganic solid electrolyte in addition to the aforementioned solid electrolyte. A content of the oxide-based inorganic solid electrolyte is as described above.

In an embodiment, a method for manufacturing a positive electrode for an all-solid-state rechargeable battery includes (i) mixing sulfide-based solid electrolyte particles, a carbon material, and a (meth)acrylate including an alkylene glycol unit in a solvent and then drying to prepare a composite material, (ii) mixing the composite material, a positive electrode active material, and a binder to prepare a positive electrode composition, and (iii) coating the positive electrode composition on a current collector.

In the positive electrode manufactured by the above method, a solid electrolyte in the form of a thin coating of the (meth)acrylate including the alkylene glycol unit on the surface of sulfide-based solid electrolyte particles, and a conductive material in which the (meth)acrylate including the alkylene glycol unit is coated on the surface of a carbon material are evenly dispersed, and these and the positive electrode active material are closely connected. Accordingly, a positive electrode having high energy density and high ionic and electronic conductivity can be provided, and because the sulfide-based solid electrolyte particles are stably coated with an organic material, the problem of deterioration due to heat and moisture is resolved, thereby providing a positive electrode having improved performance.

In the step (i), the solvent may be, for example, isobutyl isobutyrate, xylene, toluene, benzene, hexane or a combination thereof, and the drying may be, for example, vacuum drying at a temperature of 40° C. to 80° C. for 0.1 to 40 hours, or drying in an inert gas at a temperature of 60° C. to 300° C. for 0.1 to 40 hours. In the step (i), the solvent is removed by drying, thereby producing a solid electrolyte-conductive material composite in which a solid electrolyte in which a (meth)acrylate including an alkylene glycol unit is thinly coated on the surface of sulfide-based solid electrolyte particles and a conductive material in which a (meth)acrylate including an alkylene glycol unit is coated on the surface of a carbon material are well mixed.

The step (ii) may be carried out, for example, in a dry manner. Conventional electrodes are generally manufactured using a wet coating method, but this method has problems such as solvent toxicity, chemical side reactions between electrode materials and solvents, and deterioration of physicochemical properties of the coated electrode. In addition, in the case of the wet method, the electrode material should be dispersed in a solvent, then coated on the current collector, and then the solvent should be removed through a drying process in an oven or the like, which takes time and energy and increases the cost. On the other hand, introducing a dry method in electrode manufacturing can greatly increase productivity, reduce the cost of solvent drying equipment, and reduce the space occupied by the solvent drying equipment, thereby lowering the overall cost. In addition, it is possible to prevent deterioration of electrode materials due to solvents, making it possible to manufacture high-quality electrodes.

However, in the case of the dry process, there is a problem that a large amount of binder is required, the solid electrolyte is deteriorated by the heat generated during the dry process, and the solid electrolyte is also deteriorated by the moisture that flows in.

On the other hand, even if the positive electrode according to an embodiment is manufactured by a dry process, the problem of the sulfide-based solid electrolyte particles being deteriorated by heat and moisture during the dry process is improved by introducing the aforementioned solid electrolyte, and also, due to excellent dispersibility, the positive electrode can be manufactured with a small amount of binder, so that the binder content can be reduced.

The step (ii) may be, for example, mixing the composite material, the positive electrode active material, and the binder (without a solvent), extruding the mixture using an extruder, and crushing the mixture to produce a positive electrode powder. Thereafter, the positive electrode powder manufactured in step (iii) may be roll-pressed onto a current collector to manufacture the positive electrode.

### Negative Electrode

A negative electrode for an all-solid-state rechargeable battery may include, for example, a current collector and a negative electrode active material layer on the current collector. The negative electrode active material layer includes a negative electrode active material and may further include a binder, a conductive material, and/or a solid electrolyte.

The negative electrode active material may include a material capable of reversibly intercalating/deintercalating lithium ions, lithium metal, an alloy of lithium metal, a material capable of doping and dedoping lithium, or a transition metal oxide.

The material capable of reversibly intercalating/deintercalating lithium ions may include, for example crystalline carbon, amorphous carbon, or a combination thereof as a carbon-based negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

For example, the negative electrode active material may include silicon-carbon composite particles. An average particle diameter (D50) of the silicon-carbon composite particles may be for example 0.5 μm to 20 μm. The average particle diameter (D50) is measured with a particle size analyzer and means a diameter of particles with a cumulative volume of 50 volume % in the particle size distribution. Silicon may be included in an amount of 10 wt % to 60 wt % and carbon may be included in an amount of 40 wt % to 90 wt % based on 100 wt % of the silicon-carbon composite particles.

For example, the silicon-carbon composite particles may include a core including silicon particles, and a carbon coating layer on the surface of the core. An average particle diameter (D50) of the silicon particles may be 10 nm to 1 μm or 10 nm to 200 nm in the core. The silicon particles may exist as silicon alone, in the form of a silicon alloy, or in an oxidized form. The oxidized form of silicon may be represented by SiOₓ (0<x<2). In addition, a thickness of the carbon coating layer may be about 5 nm to 100 nm.

As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not exist in the core but only in the carbon coating layer.

The crystalline carbon may be artificial graphite, natural graphite, or a combination thereof, and the amorphous carbon may be may be formed from coal-based pitch, mesophase pitch, petroleum-based pitch, coal-based oil, heavy petroleum oil, or a polymer resin (phenolic resin, furan resin, polyimide, etc.). Here, a content of the crystalline carbon may be 10 wt % to 70 wt % and a content of the amorphous carbon may be 20 wt % to 40 wt % based on 100 wt % of the silicon-carbon composite particles.

In the silicon-carbon composite particle, the core may include a void in the center. A radius of the void may be 30 length % to 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si-based negative electrode active material or Sn-based negative electrode active material may be used by mixing with a carbon-based negative electrode active material. The mixing ratio of the Si-based negative electrode active material or Sn-based negative electrode active material and the carbon-based negative electrode active material may be 1:99 to 90:10 by weight.

In the negative electrode active material layer, the negative electrode active material may be included in an amount of about 95 wt % to about 99 wt % based on the total weight of the negative electrode active material layer.

In an embodiment, the negative electrode active material layer further includes a binder and may optionally further include a conductive material. A content of the binder in the negative electrode active material layer may be 1 wt % to 5 wt % based on the total weight of the negative electrode active material layer. In addition, when further including a conductive material, the negative electrode active material layer may include 90 to 98 wt % of the negative electrode active material, 1 to 5 wt % of the binder, and 1 to 5 wt % of the conductive material.

The binder serves to attach the negative electrode active material particles well to each other and also to attach the negative electrode active material well to the current collector. The binder may include a water-insoluble, a water-soluble binder, or a combination thereof.

The water-insoluble binder may include, for example polyvinylchloride, carboxylated polyvinylchloride, polyvinylfluoride, an ethylene oxide-containing polymer, ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a thickener capable of imparting viscosity may be used together, and the thickener may include, for example, a cellulose-based compound. The cellulose-based compound may include carboxymethyl cellulose, hydroxypropylmethyl cellulose, methyl cellulose, an alkali metal salt thereof, or a combination thereof. The alkali metal may be Na, K, or Li. The amount of the thickener used may be 0.1 parts by weight to 3 parts by weight based on 100 parts by weight of the negative electrode active material.

The conductive material is used to provide conductivity to the electrode, and may include, for example, carbon-based materials such as natural graphite, artificial graphite, carbon black, acetylene black, ketjen black, a carbon fiber, and a carbon nanotube; a metal-based material in the form of metal powder or metal fibers, including copper, nickel, aluminum, and silver; a conductive polymer such as a polyphenylene derivative; or mixtures thereof.

The negative electrode current collector may include one selected from a copper foil, a nickel foil, a stainless steel foil, a titanium foil, a nickel foam, a copper foam, a polymer substrate coated with a conductive metal, and a combination thereof.

Meanwhile, according to an embodiment, the negative electrode for an all-solid-state rechargeable battery may include the aforementioned solid electrolyte. According to this, the negative electrode for the all-solid-state rechargeable battery includes a current collector and a negative electrode active material layer on the current collector, wherein the negative electrode active material layer includes a negative electrode active material and the aforementioned solid electrolyte, and may optionally further include a binder and/or a conductive material.

For example, the positive electrode active material layer may be designed so that the solid electrolyte is included only in a region adjacent to the surface in contact with the solid electrolyte layer. As another example, the solid electrolyte layer may be designed to have a concentration gradient in which the content of the solid electrolyte gradually decreases in the opposite direction (toward the current collector) from the surface in contact with the negative electrode active material layer.

When the aforementioned solid electrolyte is applied to the negative electrode for an all-solid-state rechargeable battery, the ionic conductivity of the negative electrode can be increased while the resistance can be reduced, and it is possible to manufacture a positive electrode of excellent quality even with a small amount of binder.

A content of the solid electrolyte in the negative electrode may be 0.1 wt % to 35 wt %, for example, 0.5 wt % to 30 wt %, 1 wt % to 25 wt %, 3 wt % to 20 wt %, or 5 wt % to 17 wt % based on 100 wt % of the negative electrode active material layer.

In another embodiment, the negative electrode for the all-solid-state rechargeable battery may be a precipitation-type negative electrode. The precipitation-type negative electrode means a negative electrode that does not include a negative electrode active material when the battery is assembled, but in which lithium metal or the like is precipitated when the battery is charged and this acts as a negative electrode active material.

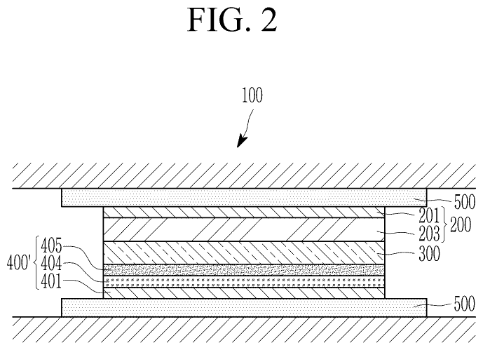

FIG. 2 is a schematic cross-sectional view of an all-solid-state rechargeable battery including a precipitation-type negative electrode. Referring to FIG. 2, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of a negative electrode active material, and when charging, a high-density lithium metal or the like is precipitated between the current collector 401 and the negative electrode coating layer 405 to form a lithium metal layer 404, which can serve as a negative electrode active material. Accordingly, in an all-solid-state rechargeable battery that has been charged more than once, the precipitation-type negative electrode 400′ may include a current collector 401, a lithium metal layer 404 on the current collector, and a negative electrode coating layer 405 on the metal layer. The lithium metal layer 404 refers to a layer in which lithium metal, etc. is precipitated during the charging process of the battery, and may be referred to as a metal layer or a negative electrode active material layer.

The negative electrode coating layer 405 may include a metal, a carbon material, or a combination thereof that acts as a catalyst.

The metal may include, for example, gold, platinum, palladium, silicon, silver, aluminum, bismuth, tin, zinc, or a combination thereof, and may be composed of one of these or various types of alloys. If the metal is present in particle form, an average particle diameter (D50) thereof may be less than or equal to about 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

If the negative electrode coating layer 405 includes the metal and the carbon material, the metal and the carbon material may be, for example, mixed in a weight ratio of 1:10 to 2:1. Here, the precipitation of the lithium metal may be effectively promoted and improve characteristics of the all-solid-state rechargeable battery. The negative electrode coating layer 405 may include, for example, a carbon material on which a catalyst metal is supported or a mixture of metal particles and carbon material particles.

The negative electrode coating layer 405 may include, for example, the metal and amorphous carbon, in which case it can effectively promote the precipitation of lithium metal.

The negative electrode coating layer 405 may further include a binder, and the binder may be a conductive binder. Additionally, the negative electrode coating layer 405 may further include general additives such as a filler, a dispersant, an ion conductive agent, and the like.

A thickness of the negative electrode coating layer 405 may be for example 100 nm to 20 μm, 500 nm to 10 μm, or 1 μm to 5 μm.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, for example in a vacuum deposition method, a sputtering method, a plating method, and the like. The thin film may have, for example, a thickness of 1 nm to 500 nm.

### Solid Electrolyte Layer

The solid electrolyte layer 300 may include a sulfide-based solid electrolyte, an oxide-based solid electrolyte, etc. For example, the solid electrolyte layer 300 may include the solid electrolyte described above.

Meanwhile, the average particle diameter (D50) of the solid electrolyte included in the solid electrolyte layer 300 may be larger than the average particle diameter (D50) of the solid electrolyte included in the positive electrode 200. In this case, the energy density of the all-solid-state rechargeable battery may be maximized while increasing the mobility of lithium ions to improve the overall performance. For example, the average particle diameter (D50) of the solid electrolyte included in the positive electrode 200 may be 0.1 μm to 1.9 μm, or 0.1 μm to 1.0 μm, and the average particle diameter (D50) of the solid electrolyte included in the solid electrolyte layer 300 may be 2.0 μm to 5.0 μm, or 2.0 μm to 4.0 μm, or 2.5 μm to 3.5 μm. When these particle size ranges are satisfied, the energy density of the all-solid-state rechargeable battery may be maximized while the transfer of lithium ions is facilitated, thereby suppressing resistance and improving the overall performance of the all-solid-state rechargeable battery. Here, the average particle diameter (D50) of the solid electrolyte can be measured using a particle size analyzer using laser diffraction.

The solid electrolyte layer may further include a binder in addition to the solid electrolyte. At this time, a styrene butadiene rubber, polytetrafluoroethylene, polyvinylidene fluoride, polyethylene, an acrylate polymer, or a combination thereof can be used as a binder, but is not limited thereto, and any binder used in the relevant technical field can be used. The acrylate polymer may be, for example, butyl acrylate, polyacrylate, polymethacrylate, or a combination thereof.

The solid electrolyte layer may be formed by adding a solid electrolyte to a binder solution, coating the same on a base film, and drying. The solvent of the binder solution may be isobutyryl isobutyrate, xylene, toluene, benzene, hexane, or a combination thereof. Because the solid electrolyte layer formation process is widely known in the art, a detailed description thereof will be omitted.

A thickness of the solid electrolyte layer may be, for example, 10 μm to 150 μm.

The solid electrolyte layer may further include an alkali metal salt, and/or an ionic liquid, and/or a conductive polymer.

For example, the alkali metal salt may be lithium salt. The content of lithium salt in the solid electrolyte layer may be greater than or equal to 1 M or for example 1 M to 4 M. In this case, the lithium salt may improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato)borate (LiBOB), lithium oxalyldifluoroborate (LIODFB), lithium difluoro(oxalato)borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbFe, LiClO₄, or a mixture thereof.

In addition, the lithium salt may be an imide-based lithium salt, and for example, the imide-based lithium salt may include lithium bis(trifluoro methanesulfonyl)imide (LiTFSI, LiN(SO₂CF₃)₂), lithium bis(fluorosulfonyl)imide (LiFSI, LiN(SO₂F)₂). The lithium salt can maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and b) at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl) imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

An all-solid-state rechargeable battery may be a unit cell with a structure of positive electrode/solid electrolyte layer/negative electrode, a bicell with a structure of positive electrode/solid electrolyte layer/negative electrode/solid electrolyte layer/positive electrode, or a stacked battery in which the structure of the unit cell is repeated.

The shape of the all-solid-state rechargeable battery is not particularly limited, and may be, for example, coin-shaped, button-shaped, sheet-shaped, stacked-shaped, cylindrical, flat, etc. In addition, the all-solid-state rechargeable battery may be applied to a large-sized battery used in an electric vehicle or the like. For example, the all-solid-state rechargeable battery may also be used in hybrid vehicles such as plug-in hybrid electric vehicles (PHEV). In addition, it may be used in a field requiring a large amount of power storage, and may be used, for example, in an electric bicycle or a power tool.

### MODE FOR INVENTION

Hereinafter, examples and comparative examples of the present invention will be described. The following examples are only examples of the present invention and the present invention is not limited to the following examples.

### Example 1

### 1. Manufacturing of Positive Electrode

Argyrodite-type sulfide-based solid electrolyte particles (Li₆PS₅Cl) with an average particle diameter (D50) of 0.85 μm are prepared, and about 3.4 parts by weight of carbon nanotubes are prepared per 100 parts by weight of the sulfide-based solid electrolyte particles. Based on a total of 100 parts by weight of the sulfide-based solid electrolyte particles and carbon nanotubes, 0.05 parts by weight of poly(ethylene glycol) diacrylate (weight average molecular weight: 420 g/mol) is prepared and mixed in xylene solvent for 30 minutes. Then, vacuum-dry at 60° C. for 60 minutes to remove the solvent and manufacture a solid electrolyte-conductive material composite.

The prepared solid electrolyte-conductive material composite and the positive electrode active material (LiNi_{0.9440}Co_{0.04}Al_{0.012}Mn_{0.004}O₂), and polytetrafluoroethylene (PTFE) binder are mixed so that the weight ratios of the solid electrolyte, conductive material, positive electrode active material, and binder are 8.7:0.3:90:1.0 in that order.

This mixture is extruded through a 60° C. extruder, and the obtained product is crushed at 10,000 rpm for 2 minutes to produce a positive electrode powder. This is rolled onto a current collector using a 60° C. roll press to manufacture a positive electrode.

2. Manufacturing of all-Solid-State Rechargeable Battery Cell

A catalyst is prepared by mixing carbon black having a primary particle diameter of about 30 nm and silver (Ag) having an average particle diameter (D50) of about 60 nm in a weight ratio of 3:1, and 0.25 g of the catalyst is added to 2 g of NMP solution including 7 wt % of polyvinylidene fluoride binder and mixed to prepare a negative electrode coating layer composition. This is coated onto a negative electrode current collector and then dried to prepare a precipitation-type negative electrode in which a negative electrode coating layer is formed on the current collector.

A composition for forming a solid electrolyte layer is prepared by adding and mixing an argyrodite-type solid electrolyte of Li₆PS₅Cl and an IBIB solvent including an acrylic binder. The composition is cast onto a releasing film and dried at room temperature to produce a solid electrolyte layer.

The prepared positive electrode, negative electrode, and solid electrolyte layers are cut, the solid electrolyte layer is stacked on the positive electrode, and then the negative electrode is stacked thereon. This is sealed in a pouch shape and subjected to warm isostatic press (WIP) at high temperature at 80° C. and 500 MPa for 30 minutes to manufacture an all-solid-state rechargeable battery cell (mini cell).

### Example 2

A positive electrode and an all-solid-state rechargeable battery cell are manufactured using the same method as in Example 1, except that di(ethylene glycol) methyl ether methacrylate is used instead of poly(ethylene glycol) diacrylate.

### Example 3

A positive electrode and an all-solid-state rechargeable battery cell are manufactured using the same method as in Example 1, except that poly(ethylene glycol) methylethermethacrylate is used instead of poly(ethylene glycol) diacrylate.

### Example 4

A positive electrode and an all-solid-state rechargeable battery cell are manufactured using the same method as Example 1, except that poly(ethylene glycol) diacrylate and di(ethylene glycol) methyl ether methacrylate are used.

### Comparative Example 1

A positive electrode and an all-solid-state rechargeable battery cell are manufactured in the same manner as in Example 1, except that poly(ethylene glycol) diacrylate is not added.

### Comparative Example 2

A positive electrode and an all-solid-state rechargeable battery cell are manufactured in the same manner as in Example 1, except that polyethylene glycol (PEG) having a weight average molecular weight of 1,000 g/mol is used instead of poly(ethylene glycol) diacrylate.

### Comparative Example 3

A positive electrode and an all-solid-state rechargeable battery cell are manufactured in the same manner as in Example 1, except that ethylhexyl acrylate having a weight average molecular weight of 4,000 g/mol is used instead of poly(ethylene glycol) diacrylate.

### Evaluation Example: Evaluation of Initial Discharge Capacity and Initial Charge/Discharge Efficiency

For the mini-cells manufactured in Examples 1, 2, and Comparative Example 1, the initial discharge capacity is measured by charging them at a constant current of 0.1 C at 45° C. to an upper limit voltage of 4.25 V and at a constant voltage of 0.05 C, and then discharging them at 0.1 C to an end-of-discharge voltage of 2.5 V. In addition, the ratio of the initial discharge capacity to the initial charge capacity is calculated, and is shown in Table 1.

TABLE 1

| | Initial discharge capacity | Initial charge/discharge |
|---|---|---|
| | (mAh/g) | efficiency (%) |
| Example 1 | 186 | 82 |
| Example 2 | 181 | 84 |
| Example 3 | 177 | 75 |
| Example 4 | 164 | 81 |
| Comparative | 127 | 59 |
| Example 1 | | |
| Comparative | 120 | 62 |
| Example 2 | | |
| Comparative | 105 | 63 |
| Example 3 | | |

Referring to Table 1, the initial discharge capacity increased and the initial charge/discharge efficiency is improved for Examples 1 and 2 compared to Comparative Examples 1 to 3.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: all-solid-state battery
200: positive electrode
201: positive electrode current collector
203: positive electrode active material layer
300: solid electrolyte layer
400: negative electrode
401: negative electrode current collector
403: negative electrode active material layer
400′: precipitation-type negative electrode
404: lithium metal layer
405: negative electrode coating layer
500: elastic layer

1. A solid electrolyte, comprising
sulfide-based solid electrolyte particles, and a coating layer on a surface of the sulfide-based solid electrolyte particles,
wherein the coating layer includes a (meth)acrylate including an alkylene glycol unit.

2. The solid electrolyte as claimed in claim 1, wherein
the (meth)acrylate including the alkylene glycol unit is (meth)acrylate including an ethylene glycol unit.

3. The solid electrolyte as claimed in claim 1, wherein
the (meth)acrylate including the alkylene glycol unit is represented by Chemical Formula 1 or Chemical Formula 2: 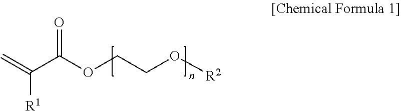
wherein, in Chemical Formula 1, R¹ is hydrogen or a methyl group, R² is a substituted or unsubstituted C1 to C20 alkyl group, and n is 2 to 100, 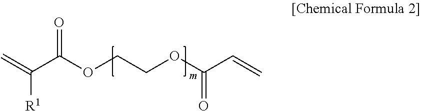
wherein, in Chemical Formula 2, R³ is hydrogen or a methyl group, and m is 2 to 100.

4. The solid electrolyte as claimed in claim 1, wherein
the (meth)acrylate including the alkylene glycol unit one or two or more selected from poly(ethylene glycol) methyl ether (meth)acrylate, poly(ethylene glycol) ethyl ether (meth)acrylate, poly(ethylene glycol) di(meth)acrylate, di(ethylene glycol) di(meth)acrylate, tri(ethylene glycol) di(meth)acrylate, di(ethylene glycol) 2-ethylhexyl ether (meth)acrylate, di(ethylene glycol) methyl ether (meth)acrylate, and di(ethylene glycol) ethyl ether (meth)acrylate.

5. The solid electrolyte as claimed in claim 1, wherein
a weight average molecular weight of the (meth)acrylate including the alkylene glycol unit is 100 g/mol to 500 g/mol.

6. The solid electrolyte as claimed in claim 1, wherein
a content of the (meth)acrylate including the alkylene glycol unit is 0.001 parts by weight to 10 parts by weight based on 100 parts by weight of the sulfide-based solid electrolyte particles.

7. The solid electrolyte as claimed in claim 1, wherein
a thickness of the coating layer is 1 nm to 50 nm.

8. The solid electrolyte as claimed in claim 1, wherein
the sulfide-based solid electrolyte particle includes an argyrodite-type sulfide.

9. The solid electrolyte as claimed in claim 1, wherein
an average particle diameter (D50) of the solid electrolyte is 0.1 μm to 5.0 μm.

10. A solid electrolyte membrane for an all-solid-state rechargeable battery, comprising the solid electrolyte as claimed in claim 1.

11. The solid electrolyte membrane for the all-solid-state rechargeable battery as claimed in claim 10, wherein
an average particle diameter (D50) of the solid electrolyte is 2.0 μm to 5.0 μm.

12. A positive electrode for an all-solid-state rechargeable battery, comprising
a current collector, and a positive electrode active material layer on the current collector,
wherein the positive electrode active material layer includes the solid electrolyte as claimed in claim 1, a positive electrode active material, a conductive material, and a binder.

13. The positive electrode for the all-solid-state rechargeable battery as claimed in claim 12, wherein
an average particle diameter (D50) of the solid electrolyte is 0.1 μm to 1.9 μm, and
an average particle diameter (D50) of the positive electrode active material is 3 μm to 25 μm.

14. The positive electrode for the all-solid-state rechargeable battery as claimed in claim 12, wherein
the conductive material includes a carbon material and a (meth)acrylate including an alkylene glycol unit on a surface of the carbon material.

15. The positive electrode for the all-solid-state rechargeable battery as claimed in claim 14, wherein
the carbon material is a carbon nanotube, a carbon nanofiber, or a combination thereof.

16. The positive electrode for the all-solid-state rechargeable battery as claimed in claim 14, wherein
a content of the carbon material is 1 part by weight to 50 parts by weight based on 100 parts by weight of the sulfide-based solid electrolyte particles.

17. The positive electrode for the all-solid-state rechargeable battery as claimed in claim 14, wherein
in the positive electrode for an all-solid-state rechargeable battery, a content of the (meth)acrylate including the alkylene glycol unit is 0.001 parts by weight to 10 parts by weight based on 100 parts by weight of the sulfide-based solid electrolyte particles and the carbon material.

18. The positive electrode for the all-solid-state rechargeable battery as claimed in claim 12, wherein
the positive electrode active material includes lithium cobalt oxide, lithium nickel oxide, lithium nickel cobalt oxide, lithium nickel cobalt aluminum oxide, lithium nickel cobalt manganese oxide, lithium nickel manganese oxide, lithium manganese oxide, lithium iron phosphate, or a combination thereof.

19. The positive electrode for the all-solid-state rechargeable battery as claimed in claim 12, wherein
the positive electrode active material layer includes
55 wt % to 99 wt % of the positive electrode active material,
0.5 wt % to 35 wt % of the solid electrolyte,
0.1 wt % to 5 wt % of the binder, and
0.1 wt % to 5 wt % of the conductive material based on 100 wt % of the positive electrode active material layer.

20. An all-solid-state rechargeable battery, comprising
a positive electrode, a negative electrode, and a solid electrolyte layer between the positive electrode and negative electrode,
wherein at least one of the positive electrode, negative electrode, and solid electrolyte layer includes the solid electrolyte as claimed in claim 1.
